(19) United States
(12) Patent Application Publication
(10) Pub. No.: US 2019/0202111 A1
(43) Pub. Date: Jul. 4, 2019

(54) DEVICE FOR PRODUCING COMPONENTS AND PRODUCTION METHOD

(71) Applicant: HOMAG Bohrsysteme GmbH, Herzebrock-Clarholz (DE)

(72) Inventor: Thomas BETTERMANN, Bielefeld (DE)

(21) Appl. No.: 16/305,851

(22) PCT Filed: May 31, 2017
(86) PCT No.: PCT/EP2017/063131

§ 371 Date: Nov. 29, 2018

(30) Foreign Application Priority Data
Jun. 1, 2016 (DE) 10 2016 209 612.5

(51) Int. Cl. B29C 64/118; F16B 12/04; B29C 64/135; B29C 64/20

(52) U.S. Cl. CPC B29C 64/118; F16B 12/04; G05B 2219/39156; B29C 64/20; G05B 2219/49023; B29C 64/135

(57) ABSTRACT

The invention relates to a device and to a method for producing components which are to be used, for example in the field of furniture and components industry. These components can be for example, tables, chairs, cabinets, furniture fronts, frame elements or similar.

### TECHNICAL FIELD

The present invention relates to a device and a method with which components can be produced which can be used, for example, in the field of the furniture and component industry. Purely by way of example, the mentioned components can be tables, chairs, cabinets, furniture fronts, frame elements or the like.

### PRIOR ART

In the production of workpieces in the field of the furniture and component industry, it is common that initial workpieces made from wood or wood materials are connected with one another. The different initial workpieces can thereby be produced with different methods and processed, and these optionally differently produced initial workpieces are connected to one another by means of glue or other connection means such as dowels, nails, screws or the like. Connecting individual workpiece elements can be carried out by the consumer if, for example, a cabinet or a table is assembled from individual elements. Further, the components can also, however, be attached to one another by the manufacturer.

In the field of the furniture and component industry, 3D printing methods (for example melt layer methods) are gaining in significance. Generally, it is known with melt layer methods to underlay overhangs on workpieces to be produced with an angle below 45° with support structures. Without such types of support structures it would not possible to work with a 3-axis-print head. After the production of the workpiece by means of the melt layer method using the aforementioned support structures has been completed, i.e. the used paste-like compound is at least partially cured, the support structures are removed again. This can also occur mechanically through corresponding exertion of force or by dissolving the support structures into a liquid substance. However, this approach is not only time and cost-intensive. Moreover, it can be necessary to dispose of the removed materials as special waste.

### SUBJECT MATTER OF THE INVENTION

Consequently, the goal of the present invention is to provide a device as well as a method to produce workpieces in a flexible manner, yet with reduced time expenditure and costs.

The subject matter of claim 1 provides a corresponding device. In the independent method claim, a corresponding method is shown as a solution. The preferred embodiments stated in the dependent claims can each be independently combined with features of the method claims and/or device claims.

The present invention has the advantage that components can be produced by means of a hybrid method. Consequently, it is possible to enable the creation of complex structures with a shorter production time. In particular, sections of the components can be created with pre-finished workpieces which do not require, for example, a free-form method. Furthermore, such pre-fabricated workpieces can be used in order to create undercuts, projections or the like which would not be possible with only an additive method.

Furthermore, the invention has the advantage that a three-dimensional body can be created at a certain location on a workpiece or it can be connected with the workpiece. It is therefore no longer necessary to produce the three-dimensional body, which may have a complex structure, in advance and to attach or fasten it to the workpiece manually or mechanically. Instead, the production process for the three-dimensional body can be linked with its connection to a workpiece.

Moreover, it is ensured, according to the preferred embodiments, that a material for creating a three-dimensional body by means of an additive method, which in particular comprises a paste-like compound, develops a strong adhesive effect to the workpiece. Consequently, two processes which are conventionally separated from one another can be combined.

The present invention provides a device for producing components, in particular furniture pieces, with the device having: a workpiece holder, in particular a machine table or a machine bed for accommodating a workpiece, a handling device which has a handling unit to pick up, raise and/or move a workpiece, and a unit for forming a three-dimensional body by means of an additive method.

It is thereby preferred that a paste-like compound is used within the scope of the additive method. The unit for forming a three-dimensional body is preferably configured to handle and/or discharge and/or apply a paste-like compound.

According to one modification, a material for creating a three-dimensional body by means of an additive method comprises a foam, in particular PU foam, metal foam or wood foam.

According to one embodiment, a material for creating a three-dimensional body by means of an additive method comprises a biological polymer which in particular has lignin and/or natural fibers, with the natural fibers further preferably being formed from wood, flax, hemp, sisal, jute and/or other plant fibers.

According to one modification, a material for creating a three-dimensional body by means of an additive method has a metallic or mineral paste and/or a paste-like, in particular thermoplastic or duroplastic, synthetic material compound, with the synthetic material compound further preferably having fibers.

It is further preferred that the workpiece is a plate-like workpiece. Consequently, the handling device is preferably configured to pick up, raise and/or move a plate-like workpiece. For example, the handling device as a handling unit can have suction cups or a workpiece gripper.

According to one preferred embodiment, the handling device is a robotic arm.

The handling device can be connected with the workpiece holder, in particular the machine bed/machine table, or arranged beside it.

According to one preferred embodiment, the unit for forming a three-dimensional body is connected with the machine bed/machine table, or arranged beside it.

According to one preferred embodiment, it is provided that the unit for forming a three-dimensional body is an extruder. It is thereby preferred that the extruder has an extruder screw accommodated in a main body. Consequently, the additive production of a three-dimensional body can be carried out comparatively cost-effectively. In particular, a granulate for production thereof is available cost-effectively. According to one further embodiment, the extruder can be configured to convey a filament. The heated filament is used to form a three-dimensional body. According to one further embodiment, the extruder is configured to convey a foam material. In this case, the foam material is used to form the three-dimensional body.

It is further preferred that the unit for forming a three-dimensional body is moveable in a vertical direction and in a horizontal direction. In a further modification, it is preferred that the unit for forming the three-dimensional body is pivotable around an axis, further preferably around two or more axes. In this way, the variability is increased further.

The handling unit can comprise a suction clamp or a workpiece gripper so that workpieces, or also three-dimensional bodies can be rapidly picked up. A suction clamp can pick up a workpiece preferably on one side of the workpiece.

It is preferred that the handling device is configured multi jointed and/or pivotable around at least one axis, preferably two axes. In this way, the variability of the apparatus is increased further.

According to one further embodiment, the handling device is attached to a first moveable unit, in particular a cantilever or a gantry, and/or the unit for forming a three-dimensional body is attached to a second moveable unit, in particular a cantilever or a gantry.

It is in this context further preferred that the first moveable unit and/or the second moveable unit is or are moveable along a guide of the workpiece holder, in particular the machine bed. Consequently, the device according to this embodiment can be operated flexibly. It is also possible to handle and/or machine larger workpieces.

It can be provided that the device further comprises a machining device having a tool for machining, in particular a milling tool, a saw or a drill, with it being preferred that the machining device is attached to the first moveable unit. Furthermore, it can be preferable that the handling device is attached to or picked up by the first moveable unit. Consequently, several functions are unified into one device in an advantageous manner.

For example, with the machining device a workpiece can be carved, in particular separated, from an initial workpiece in a so-called nesting method. When carving, in particular separating, several workpieces can be obtained from one initial workpiece. By means of the handling device, a workpiece can be selected from the several workpieces and extracted.

According to one alternative or additional variant, the machining device can be used for post-processing, for example, for edge finishing, in particular sanding or milling, smoothing the surface, etc.

Preferably, the workpiece holder has a preferably level workpiece support surface for accommodating an in particular plate-like workpiece. In particular, it is thereby provided that the workpiece support surface has suction ports in order to hold an in particular plate-like workpiece on the workpiece support surface. Consequently, for example, workpieces can be picked up which have been produced in the nesting method, or larger workpieces can also be picked up and, optionally, machined.

According to one further variant, the workpiece support surface, or sections thereof, can be moveable. Embodiments of a moveable workpiece support surface are, for example, a conveying element, in particular a conveyor band, one or more conveyor belts, one or more conveyor chains or moveable retaining elements. A moveable workpiece support surface can, for example, be used advantageously in a nesting method.

According to one modification, the workpiece holder comprises carrier members (consoles) having clamping elements, in particular vacuum suction cups.

According to a further objective of the invention, a method is provided. According to one variant, a device according to one of the preceding aspects can be used within the scope of the method.

The method comprises the steps: providing a workpiece, with the workpiece preferably being plate-like,

creating a three-dimensional body by means of an additive method, in particular by using a paste-like compound, with the three-dimensional body being formed on the workpiece or being connected with it.

If the three-dimensional body is connected with the workpiece, this step can be carried out in such a manner that firstly the three-dimensional is created and subsequently the workpiece is connected with it, or the three-dimensional body is applied to or pressed onto the workpiece.

The additive method is preferably a melt layer method which has a relatively high process reliability.

It is preferred that the workpiece has a retaining structure, in particular a recess, a through hole or a projection.

Furthermore, it can be provided that the three-dimensional body created by means of an additive method is created starting from the retaining structure of the workpiece, or the workpiece and the three-dimensional body are pressed against one another in such a manner that the three-dimensional body, in particular a paste-like compound of the three-dimensional body is formed at least partially around the retaining structure of the workpiece or penetrates into it. In this way, a hybrid method is able to be realized in an especially advantageous manner.

It can thereby be provided that on the workpiece a through hole is provided, into which a body produced with an additive method is introduced in sections. On the side of the workpiece opposite said body, a further body is produced with an additive method in the area of the through hole in such a manner that a connection is produced between the two bodies and the preferably plate-like workpiece.

According to one modification, the three-dimensional body has free-form surfaces in sections and/or the workpiece is carved, in particular cut or milled, from a preferably plate-like initial workpiece. Consequently, semi-finished products can be used in a cost-effective manner.

The workpiece can be a particle board, an MDF board, an HDF board, a lightweight board, a metal foam board, a synthetic material board or a composite material board. Such types of semi-finished products are available relatively inexpensively and can be integrated especially advantageously into, for example, furniture pieces or components from the field of the component industry.

According to one or more variants, it is first provided that one or several three-dimensional bodies are created and subsequently a further layer of the paste-like compound is applied to the one three-dimensional body or the several three-dimensional bodies in order to connect the three-dimensional body with a workpiece.

According to one embodiment of the method, the following steps can be provided; creating a three-dimensional body, subsequently providing the preferably plate-like workpiece and connecting the workpiece with the three-dimensional body (for example, by using a paste-like compound of the three-dimensional body, and subsequently creating a further three-dimensional body on the workpiece. Furthermore, it can be provided that a further workpiece is attached to the further three-dimensional body.

The method steps can be continued in alternation. Consequently, a multiple hybrid method is shown.

According to one preferred embodiment, for the step of providing the workpiece, the workpiece is carved, in particular separated, from one initial workpiece. The carving, in particular the separating, of the workpiece from an initial workpiece can occur in a so-called nesting method. Consequently, the spectrum of use of the method is expanded further.

When carving, in particular separating, several workpieces can be obtained from one initial workpiece. By means of the handling device, a workpiece can be selected from the several workpieces and moved.

### BRIEF DESCRIPTION OF THE DRAWINGS

FIG. 1 is a perspective view of a preferred embodiment of the present invention.

FIG. 2 shows a further stage of the method when using the device according to FIG. 1.

FIG. 3 is a view with which a further stage of the method is shown.

FIGS. 4a and 4b are examples of components manufactured with the device according to FIGS. 1 to 3.

### DETAILED DESCRIPTION OF THE PREFERRED EMBODIMENTS

A preferred embodiment of the present invention is described in detail below by means of the enclosed figures. Further modifications cited in this context can each be combined with one another in order to form new embodiments.

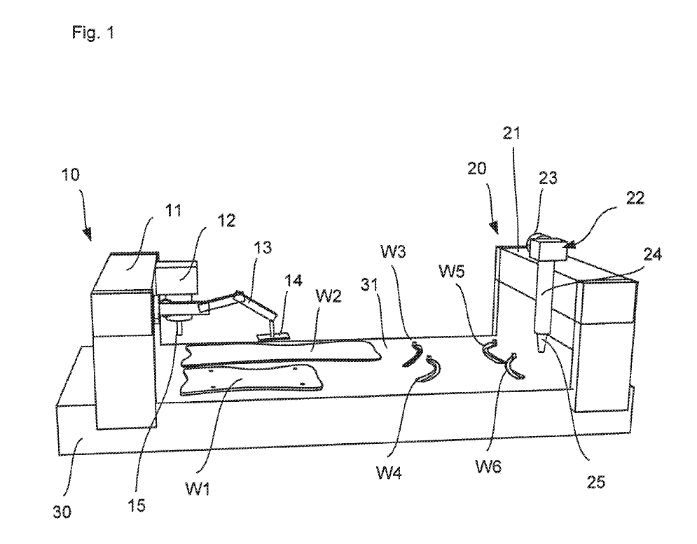

In FIG. 1, a preferred embodiment of a machining device according to the invention is shown by means of a schematic illustration. The machining device comprises a machine bed/machine table 30 (workpiece holder) which has a support surface 31 upon which the workpieces can be placed and machined. In the present embodiment, the support surface 31 is depicted by way of illustration as a flat surface which, according to one variant of the embodiment described here, is provided with vacuum openings.

However, according to a further modification, the support surface can be provided or configured with vacuum suction cups arranged on carrier members (so-called consoles). The carrier member and/or the vacuum suction cups can be configured moveably.

Although the embodiment described by means of the figures is directed at a stationary support surface 31, a moveable support surface or conveying element, in particular a conveyor band, one or more conveyor belts, one or more conveyor chains or moveable retaining elements can be provided within the scope of further embodiments, instead of the support surface on the machine bed 30.

Further, the present invention also comprises an embodiment in which clamping elements are attached to or placed on the support surface 31 in order to accommodate and, optionally, hold the workpieces described below. The support surface 31 can also have several areas which have different support surfaces or different holding and clamping mechanisms in order to pick up, and optionally to hold, workpieces.

In the present embodiment, two gantry units, namely a first gantry unit 10 and a second gantry unit 20, are provided along the machine bed 30. Both gantry units 10, 20 are movable along the machine bed 30.

It is evident that, instead of a gantry unit (or both gantry units), a cantilever unit which is only attached to a longitudinal side of the machine bed 30 can also be used. This relates to the first gantry unit 10 shown in the president embodiment as well as the second gantry unit 20.

The gantry unit 10 comprises a gantry carrier 11 which extends over the machine bed 30. Attached to the gantry carrier 11 is a first moveable unit 12 which, in the present embodiment, has a handling device 13 which is configured multi jointed corresponding to a robotic arm. The handling device 13 further comprises a handling unit 14, for example, a suction clamp, of a workpiece gripper, or the like, in order to, as described below, pick up, raise and/or move workpieces.

Further, a machining device 15 is provided on the moveable unit 12, in order to machine workpieces within the scope of a nesting method. A workpiece is thereby cut or milled from a plate-like semi-finished product. Several individual elements can also be carved from a plate-like workpiece. Accordingly, two workpieces are provided in the present embodiment example, namely a workpiece W1 and workpiece W2 which were cut from a shared initial workpiece.

The machining device 15 is accommodated in a tool holding fixture (not shown in detail) of the moveable unit 12. Since the moveable unit 12 comprises a tool holding fixture in which the machining device 15 is accommodated, it is further possible to exchange the machining device 15 for a different machining device. For example, in this manner, bores having a certain diameter can be produced in a workpiece.

The second gantry unit 20 comprises a carrier 21 which extends over the machine bed 30. Attached to this carrier is an extruder unit 22 with which a paste-like compound is discharged and a three-dimensional body can be created in the course of a melt layer method.

The extruder unit 22 comprises a motor 23 for driving an extruder screw as well as a main body 24 which accommodates the extruder screw. The main body 24 extends in the vertical direction. At an end section of the main body 24 facing the machine bed 30, a nozzle 25 is mounted, said nozzle 25 having an opening. The paste-like compound leaves the opening of the nozzle.

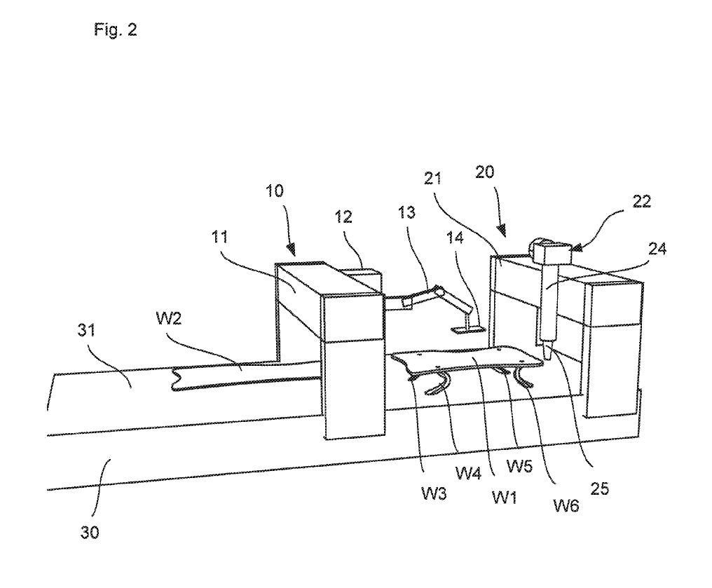

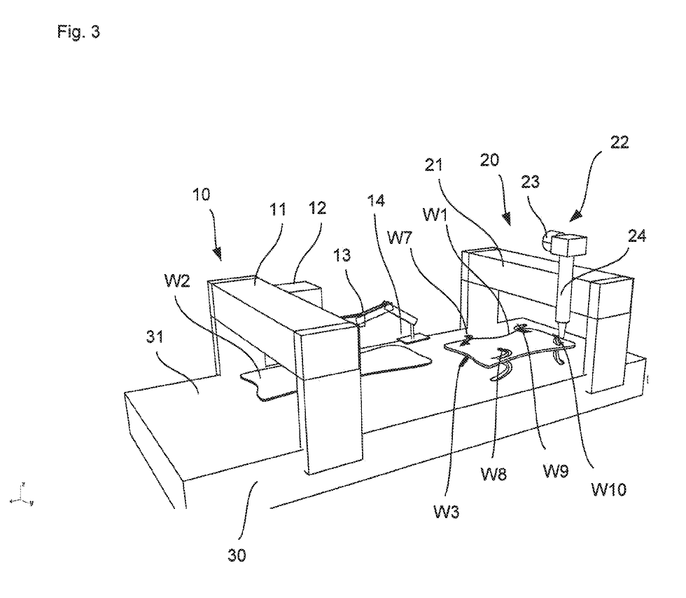

An exemplary method sequence is explained below using the FIGS. 1-3.

Firstly, an initial workpiece which is not shown in the figures is placed on the support surface 31 of the machine bed 30 and divided by means of the machining device 15 into plate-like workpieces W1 and W2. This approach is carried out within the scope of a nesting method. Alternatively, it is possible to use several initial workpieces to produce the plate-like workpieces W1 and W2 or to place the plate-like workpieces W1 and W2 already shown with the contour in the figures on the support surface 31 of the machine bed 30.

Several three-dimensional bodies W3-W6 constituting intermediate struts of a table in the embodiment example described here are produced in a further area of the support surface 31 by means of the extruder unit 22. Due to the used 3D printing method (here: melt layer method), the struts W3-W6 can be formed as free-form bodies. A fixation of the struts W3-W6 can be pressed onto/applied to one or more plates (not shown).

Subsequently, the handling device 13 is used in order to firstly pick up the plate-like workpiece W1 by means of the handling unit 14 and to place on the struts W3-W6. In this regard, the plate-like workpiece W1 is firstly picked up, then the first gantry unit 10 is moved in the direction of the second gantry unit 20, and subsequently the first plate-like workpiece W1 is placed on the end sections of the struts W3-W6.

Ideally, this occurs after in a final method step at each of the struts W3-W6 a layer of the paste-like compound has once more been applied, which is in an as yet uncured state at the time the first plate-like workpiece W1 is applied. Consequently, after the curing of the paste-like compound after the plate-like workpiece W1 has been applied, an adhesive bond between the plate-like workpiece W1 and the struts W3-W6 is produced.

Advantageously, bores are provided on the plate-like workpiece W1 on its side facing the support surface 31, into which the paste-like compound of the struts W3-W6 can penetrate. These can be through holes which have an opening on the upper side as well as the lower side of the workpiece W1.

The first plate-like workpiece W1 comprises, in the shown embodiment, several bores (optionally, upper through holes) on the main surface pointing upwards in the vertical direction. Starting from these bores, in a subsequent method step, further struts W7-W10 are formed by means of the extruder unit 22. During this process, the gantry unit 10 is driven back to the starting position (left side in FIG. 1), so that the second gantry unit 20 can be moved over the plate-like workpiece W1.

After the further struts W7-W10 have been produced in a melt layer method, a melt layer which is not yet completely cured during the application of the second plate-like workpiece W2 is applied again to their end sections pointing upwards in the vertical direction. Consequently, the second plate-like workpiece which is picked up by the handling device 13 by means of the handling unit 14 is placed and pressed onto the further struts W7-W10. During the curing of the previously applied melt layer, an adhesive bond is produced between the second plate-like workpiece W2 and the struts W7-W10.

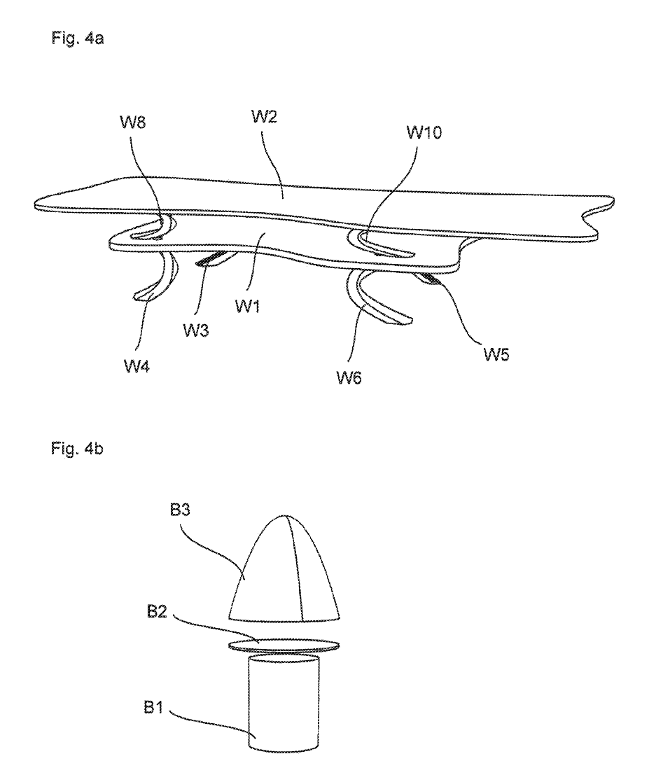

The table produced in this manner is shown in FIG. 4a. Consequently, this could be produced through a hybrid method in which free-form bodies (struts W3-W10) are produced by means of a melt layer method, whereas simple elements (the plate-like workpieces W1 and W2) are connected with the struts. The paste-like compound for forming the struts W3-W10 is thereby further used as an adhesive in order produce a connection between the corresponding elements.

A further example is shown in FIG. 4b. Hereby, a first, rod-shaped workpiece B1 is produced by means of a melt layer method and subsequently placed on a plate-like workpiece B2 and connected with it. Starting from the plate-like workpiece B2, a further three-dimensional body B3 which is dome-shaped starting from the plate-like workpiece B2 can be created with a melt layer method. Since the plate-like workpiece B2 has a larger diameter than the first rod-shaped workpiece B1, a recess can be produced. With conventional methods, the recess can only be produced with large effort.

Even if the use of the paste-like compound was described as an adhesive means within the scope of the above-described embodiment, it is evident that other connection techniques or connecting means can also be used for this method step. For example, pins having an undercut or a retaining structure which are subsequently transformed by the paste-like compound can be inserted into the plate-like workpieces. It is also possible to use an adhesive in order to connect a plate-like workpiece with a strut or a different workpiece produced in a melt layer method.

The type and design of the described workpieces W1-W10 and B1-B3 is an example. In addition to plate-like workpieces, workpieces can also be used which have been machined using a milling method in order to already form a structure.

1. A device for producing components, the device comprising:
a workpiece holder for accommodating a workpiece;
a handling device, which has a handling unit to pick up, raise and/or move a workpiece provided on the workpiece holder; and
a unit for forming a three-dimensional body by means of an additive method, using a paste-like compound.

2. The device according to claim 1, wherein the unit for forming a three-dimensional body is an extruder,
wherein the extruder has an extruder screw accommodated in a main body; and
wherein the extruder is configured to convey a filament, or the extruder is configured to convey a foam material.

3. The device according to claim 1, wherein the unit for forming a three-dimensional body is moveable in a vertical direction and in a horizontal direction relative to the workpiece holder, and
wherein the unit for forming the three-dimensional body is pivotable around at least one axis.

4. The device according to claim 1, wherein the handling unit comprises a suction clamp or a workpiece gripper.

5. The device according to claim 1, wherein the handling device is configured multi jointed and/or pivotable around at least one axis.

6. The device according to claim 1, wherein the handling device is attached to a first moveable unit, in particular a cantilever or a gantry, and/or the unit for forming a three-dimensional body is attached to a second moveable unit, in particular a cantilever or a gantry,
wherein the first and/or second unit is or are moveable along a guide provided or attached to the workpiece holder.

7. Device according to claim 1, wherein the device further comprises a machining device having a tool for machining, in particular a milling tool, a saw or a drill,
wherein the machining device is attached to a first moveable unit, and
wherein the handling device is attached to the first moveable unit.

8. The device according to claim 1, wherein the workpiece holder has a workpiece support surface for accommodating a workpiece which is plate-like, and
wherein the workpiece support surface has suction ports in order to hold the plate-like workpiece on the workpiece support surface.

9. A method for producing a component by using a device according to claim 1, having the steps:
providing a workpiece; and
creating a three-dimensional body by means of an additive method, the three-dimensional body being formed on the workpiece or connected with it.

10. The method according to claim 9, wherein the additive method is a melt layer method.

11. The method according to claim 9, wherein the workpiece has a retaining structure, in particular a recess, a through hole or a projection,
wherein the three-dimensional body is created starting from the retaining structure of the workpiece, or the workpiece and the three-dimensional body are pushed against one another in such a manner that the three-dimensional body, in particular a paste-like compound of the three-dimensional body, is formed at least partially around the retaining structure of the workpiece or penetrates into it.

12. The method according to claim 9, wherein the three-dimensional body has free-form surfaces in sections and/or the workpiece is carved, in particular cut, from a workpiece which is plate-like.

13. The method according to claim 9, wherein the workpiece is a particle board, an MDF board, an HDF board, a lightweight board, a metal foam board, a synthetic material board or a composite material board.

14. The method according to claim 9, wherein a material for creating the three-dimensional body by means of an additive method comprises a biological polymer which in particular has lignin and/or natural fibers, the natural fibers further being formed from wood, flax, hemp, sisal, jute and/or other plant fibers, or
a material for creating the three-dimensional body by means of an additive method has a metallic or mineral paste and/or a paste-like, in particular thermoplastic or duroplastic, synthetic material compound, the synthetic material compound further having fibers, or
a material for creating the three-dimensional body by means of an additive method comprises a foam, in particular PU foam, metal foam or wood foam.

15. The method according to claim 9, wherein firstly one or several three-dimensional bodies are created and subsequently a further layer of the material for creating the three-dimensional body, in particular the paste-like compound, is applied to the one three-dimensional body or the several three-dimensional bodies, in order to connect the three-dimensional body with a workpiece.

16. The method according to claim 9, characterized by the steps:
creating a three-dimensional body by means of an additive method,
subsequently providing the workpiece and connecting the workpiece with the three-dimensional body, and
subsequent creation of a further three-dimensional body on the workpiece,
wherein a further workpiece is attached to the further three-dimensional body.

17. The method according to claim 9, wherein for providing the workpiece, the workpiece is carved, in particular separated, from an initial workpiece.

18. The device according to claim 1, wherein the components comprise furniture pieces.

19. The device according to claim 1, wherein the workpiece holder comprises a machine bed.

20. The device according to claim 1, wherein the workpiece is plate-like.

21. The device according to claim 1, wherein the additive method uses a paste-like compound.

22. The method according to claim 9, wherein the component comprises a furniture piece.

23. The method according to claim 9, wherein the workpiece is plate-like.
